(19) United States
(12) Patent Application Publication
(10) Pub. No.: US 2026/0111907 A1
(43) Pub. Date: Apr. 23, 2026

(54) SYSTEM AND METHOD FOR AUTOMATED LOGGING OF USER COMPLAINTS

(71) Applicant: Honeywell International Inc., Charlotte, NC (US)

(72) Inventors: Naresh Kumar Singh, Ewing, NJ (US); Ankit Singh, Apex, NC (US)

(21) Appl. No.: 18/919,530

(22) Filed: Oct. 18, 2024

(51) Int. Cl. G06Q 30/016; G06F 16/22; G06F 16/28

(52) U.S. Cl. CPC G06Q 30/016; G06F 16/2272; G06F 16/285

(57) ABSTRACT

The present disclosure relates to a method for automated logging of user complaints within a software environment. The method includes receiving a command from a user via a user recordal interface to initiate a complaint recording. In response, the system captures user interactions with the software, which include video files, audio files, and screen capture data. The captured data is processed to extract a representation of user's actions, specifically steps required to reproduce the complaint. The method further analyzes these interactions to identify relevant system components and retrieves system data such as logs, events, and diagnostic information associated with the identified components. This system data is synchronized with the captured user interactions based on temporal or contextual markers. A support ticket is generated, aggregating the captured interactions, extracted user actions, and retrieved system data. The ticket is forwarded to a resolution system for efficient troubleshooting and resolution of the complaint.

### TECHNICAL FIELD

The present disclosure relates to automated customer support systems. More particularly, the present disclosure relates to a system and a method for automated logging of user complaints, including capturing user actions, extracting logs, and integrating retrieval-augmented generation (RAG) architecture for enhanced complaint resolution.

### BACKGROUND

In current customer support processes, resolving technical issues often involves multiple rounds of communication between customers and support teams. This back-and-forth is typically required to clarify the steps to reproduce the issue, gather relevant logs, and ensure the support or development team fully understands the problem. This iterative communication process can cause delays in the issue or complaint resolution, leading to customer dissatisfaction and inefficiencies within support systems.

Existing solutions rely on customers to manually document the complaint and explain how the issue occurred. This approach is prone to human error or incomplete documentation, which can further hinder the troubleshooting process. Moreover, current methods of log extraction, issue analysis, and complaint logging are often fragmented, requiring manual review of logs, audio inputs, and system components. As such, there is a need for a solution that automates the troubleshooting and issue reproduction process to provide more accurate and efficient support.

### SUMMARY

The present disclosure relates to a solution for automating the troubleshooting and complaint reproduction process by creating a system that records customer actions, extracts relevant logs, and leverages retrieval-augmented generation (RAG) architecture for enhanced troubleshooting support.

According to an aspect of the disclosure, a method for automated logging of user complaints is disclosed. The method comprises receiving, at a user recordal interface, a command from a user to initiate a complaint recording within a software environment. The method further comprises capturing user interactions with the software environment in response to the command, where the captured user interactions include at least one of a video file, an audio file, and screen capture data. Further, the method comprises processing the captured user interactions to extract a representation of user actions including steps required to reproduce the complaint.

Furthermore, the method comprises analysing the captured user interactions to identify one or more system components associated with the complaint and retrieving system data associated with the identified one or more system components, including one or more of logs, events, and diagnostic information. Additionally, the method comprises synchronizing the retrieved system data with the captured user interactions based on temporal or contextual markers, generating a support ticket to aggregate one or more of the captured user interactions, the extracted representation of the user actions, and the retrieved system data, and forwarding the generated support ticket to a resolution system for resolution of the complaint.

In some embodiments, the method further comprises storing the generated support ticket in a database and organizing the stored support ticket by associating the stored support ticket with one or more indexing structures, where the one or more indexing structures are configured to support the retrieval and comparison of the support ticket based on similarities in the complaint characteristics.

In some embodiments, analysing the captured user interactions comprises applying recognition techniques including one or more of optical character recognition (OCR), speech-to-text conversion, or image analysis to identify relevant system components and contextual information.

In some embodiments, retrieving the system data comprises accessing and aggregating the system data from a plurality of sources including one or more of application logs, network logs, performance metrics, and user-specific data.

In some embodiments, the method further comprises utilizing machine learning or artificial intelligence models to enhance the accuracy of the extracted representation of the user actions and the identification of one or more system components.

In some embodiments, the method further comprises presenting the generated support ticket and associated data including one or more of the captured user interactions, the extracted representation of the user actions, and the retrieved system data to the user or the resolution system via a user interface, where the presenting includes at least one of visual elements, textual elements, or interactive elements.

In some embodiments, organizing the stored support ticket comprises generating a unique identifier for the stored support ticket in the database.

In some embodiments, the representation of the user actions includes recorded steps performed by the user including at least one of clicking buttons, entering text, navigating through different screens, or other interactions with the software environment.

In yet another embodiment, a user recordal system for automated logging of user complaints is disclosed. The user recordal system comprises a user recordal interface module, a recording module, an extraction module, an analysis module, a retrieval module, a synchronization module, a ticket generation module, and a forwarding module. The user recordal interface module is configured to receive a command from a user recordal interface to initiate a complaint recording within a software environment. The recording module is configured to capture user interactions with the software environment in response to the command, where the captured user interactions include at least one of a video file, an audio file, and screen capture data. The extraction module is configured to process the captured user interactions to extract a representation of user actions including steps required to reproduce the complaint.

The analysis module is configured to analyse the captured user interactions to identify one or more system components associated with the complaint. The retrieval module is configured to retrieve system data associated with the identified one or more system components, including one or more of logs, events, and diagnostic information. The synchronization module is configured to synchronize the retrieved system data with the captured user interactions based on temporal or contextual markers. The ticket generation module is configured to aggregate one or more of the captured user interactions, the extracted representation of the user actions, and the retrieved system data into a support ticket. The forwarding module is configured to forward the generated support ticket to a resolution system for resolution of the complaint.

In some embodiments, the system further comprises a storing module configured to store the generated support ticket in a database, and where the analysis module is further configured to organize the stored support ticket by associating the stored support ticket with one or more indexing structures, where the one or more indexing structures are configured to support the retrieval and comparison of the support ticket based on similarities in the complaint characteristics.

In some embodiments, the analysis module is further configured to apply recognition techniques to analyse the captured user interactions, including one or more of optical character recognition (OCR), speech-to-text conversion, or image analysis to identify relevant system components and contextual information.

In some embodiments, the retrieval module is further configured to access and aggregate the system data from a plurality of sources including one or more of application logs, network logs, performance metrics, and user-specific data.

In some embodiments, the system further comprises a machine learning module or artificial intelligence module configured to enhance the accuracy of the extracted representation of the user actions and the identification of one or more system components.

In some embodiments, the system further comprises a user interface module configured to present the generated support ticket and associated data including one or more of the captured user interactions, the extracted representation of the user actions, and the retrieved system data to the user or the resolution system, where the presentation includes at least one of visual elements, textual elements, or interactive elements.

In some embodiments, the analysis module is further configured to generate a unique identifier for the stored support ticket in the database.

In yet another embodiment, a non-transitory computer-readable medium is disclosed, having stored thereon computer-readable instructions that, when executed by a processor, cause the processor to execute a method for automated logging of user complaints, comprising: receiving, at a user recordal interface, a command from a user to initiate a complaint recording within a software environment; capturing user interactions with the software environment in response to the command, where the captured user interactions include at least one of a video file, an audio file, and screen capture data; processing the captured user interactions to extract a representation of user actions including steps required to reproduce the complaint; analysing the captured user interactions to identify one or more system components associated with the complaint; retrieving system data associated with the identified one or more system components, including one or more of logs, events, and diagnostic information; synchronizing the retrieved system data with the captured user interactions based on temporal or contextual markers; generating a support ticket to aggregate one or more of the captured user interactions, the extracted representation of the user actions, and the retrieved system data; and forwarding the generated support ticket to a resolution system for resolution of the complaint.

The disclosed method and system significantly enhance the efficiency of the user complaint reporting and resolution process, reduce human error, and provide a more seamless and comprehensive approach to customer support in software environments.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1(a) illustrates a method of handling customer-related complaints according to the existing method used in the prior art;

FIG. 1(b) illustrates a method disclosed according to an embodiment of the disclosure;

FIG. 2 illustrates a 3D space according to an embodiment of the disclosure;

FIG. 3 illustrates a process flow for querying and retrieving information using a virtual assistant in conjunction with a Retrieval-Augmented Generation (RAG) system according to an embodiment of the disclosure;

FIG. 4 illustrates a method for automated logging of user complaints according to an embodiment of the disclosure;

FIG. 5 illustrates a user recordal system for the automated logging and resolution of user complaints according to an embodiment of the disclosure; and

FIG. 6 illustrates a schematic diagram of another communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

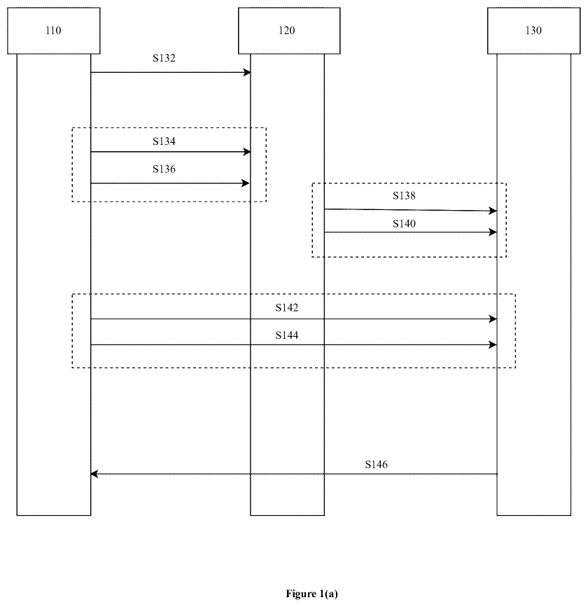

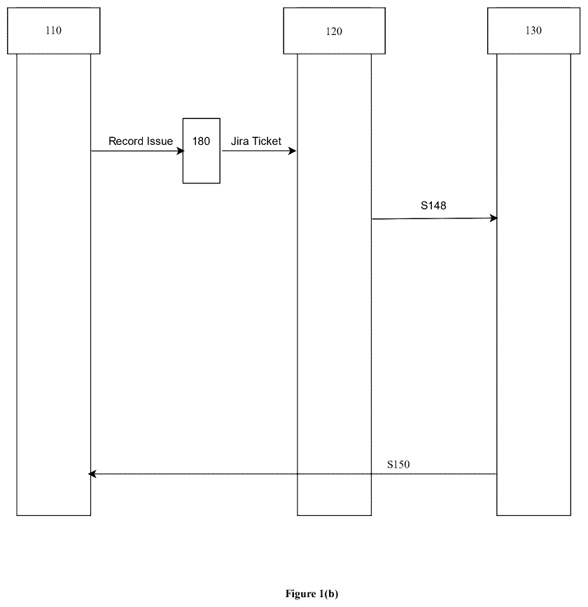

FIG. 1(a) illustrates a method of handling customer-related complaints according to the existing prior art. The method involves three key entities: customer 110, support team 120, and development team 130. This method shows how most of the time is consumed in understanding and gathering relevant information through multiple communication channels before the development team 130 provides a solution to the customer.

The process starts at step S132, where a customer 110 initiates a complaint or issue by reporting it to the support team 120. This initial communication typically happens through online portals, emails, or phone calls, depending on the available customer support infrastructure. After the complaint is logged, the support team 120 engages in further communications to gain a clearer understanding of the issue.

Once the complaint is received, the support team 120 reaches out to the customer for additional clarifications. In step S134, communication begins through email, followed by a phone call in step S136, where the customer provides further context, such as the symptoms of the issue, steps to reproduce it, or relevant screenshots and error messages. This back-and-forth conversation is critical but can be time-consuming, as the support team must gather as much detail as possible to forward a comprehensive report to the development team 130.

Following this, the support team 120 relays the gathered information to the development team 130 in step S138 via email and in step S140 via phone call to provide further insight into the nature of the complaint. This communication often includes not only the customer's input but also any technical understanding, historical data, or previous similar issues. In one embodiment, the support team 120 may also include insights regarding recurring complaints or known bugs to give the development team 130 a more complete picture.

In cases where the development team 130 requires additional clarification, they may reach out directly to the customer 110 to seek further information about the complaint. This communication is facilitated through email in step S142 and phone calls in step S144, as shown in FIG. 1(a). The development team 130 may ask for more detailed error logs, and configurations, or even perform live troubleshooting sessions with the customer.

Finally, once the development team 130 fully understands the issue, they provide a solution in step S146, which is then communicated back to the customer through the support team or directly to the customer, depending on the complexity of the resolution.

This method is characterized by its heavy reliance on back-and-forth communication between the different entities, often resulting in delays. The manual nature of issue reproduction, communication of technical insights, and the coordination required between teams lead to inefficiencies in resolving customer complaints.

In an embodiment, this process could be applied in a Saas (Software as a Service) context, where customers report software bugs. The support team may have limited technical expertise and therefore relies heavily on development teams for resolutions. For instance, a customer might encounter an application error and report it to the support team. Due to the limited information provided in the initial complaint, several rounds of clarification may be required before the development team can diagnose the issue.

In another use case involving hardware issues, the support team might have to request the customer to perform diagnostic tests or send hardware logs, which leads to further delays. The flow of communication as described in FIG. 1(a) applies, where the customer and the technical teams must go through multiple interactions to gather sufficient information.

In yet another embodiment, this method could be employed in enterprise-level software support, where the complexity of the environment (e.g., various software components, networks, and users involved) requires deep collaboration between the customer, support team, and development team. Each layer must ensure accurate communication to avoid any misunderstanding of the root cause, further illustrating the limitations of the existing method shown in FIG. 1(a).

FIG. 1(b) illustrates a method of logging and resolving a customer complaint according to an embodiment of the disclosure. This method involves the same three entities: the customer 110, the support team 120, and the development team 130, but enhances the process by introducing a user recordal interface 180 to streamline the capture and submission of issue details.

In an embodiment, the user recordal interface 180 can take the form of a button, tab, or another selectable element within the software application's user interface. When the customer encounters an issue, they can initiate the complaint logging process by interacting with the recordal interface 180. Upon activation, the system automatically captures a wide array of relevant information, significantly reducing the need for manual input by the customer.

In an embodiment, the user recordal interface 180 may be a feature integrated into a software environment, allowing users to record and submit detailed information about an issue or error they encounter during the use of a product. This interface 180 simplifies the process of capturing complex technical details such as user actions, system logs, audio explanations, and visual content. By automating the collection of critical data, the user recordal interface helps streamline troubleshooting and minimizes the need for extensive back-and-forth communication between the customer and support teams.

In an embodiment, the user recordal interface 180 may be implemented as a button. A simple “Record Issue” button that, when clicked, begins capturing user interactions, system logs, and other relevant data automatically. In an embodiment, an additional tab in the software's user interface, labeled “Report an Issue” or “Help & Support,” which provides access to recording and submission functionalities.

In an embodiment, the user recordal interface 180 may be a dropdown menu or contextual option. Accessible through a right-click contextual menu or within a dropdown menu in the user's interface, allowing users to initiate the recording without leaving their current screen.

In another embodiment, the user recordal interface 180 is an automated prompt. The system can prompt the user to record an issue automatically if it detects a recurring error or abnormal behavior, reducing the burden on the user to identify when to report problems.

In an embodiment, the recorded information may include:
Video capture of the steps leading to the issue.
Browser logs detailing any front-end errors or anomalies.
Application logs that document the performance of the software components.
Backend component information to identify server-side issues.
Frontend component information for diagnosing client-side errors.
CloudWatch logs, if applicable, which provide cloud service insights.
Timestamps and organizational stamps to ensure traceability.
Audio capture of the customer's explanation, which is then converted to text using automatic speech recognition (ASR).
Screenshots for visual reference.

Once this comprehensive data set is collected, it is automatically compiled and associated with a Jira ticket, which is then forwarded to the support team 120. The Jira ticket is a record created in the Jira software, a widely used project management and issue-tracking tool developed by Atlassian. Each Jira ticket represents a specific task, bug, issue, or feature request, and it contains detailed information about the problem or work item.

According to an embodiment, the Jira ticket typically includes an issue summary, detailed description, priority and severity, assignee, status, and comments and attachments. The issue summary provides a brief description of the problem. The detailed description provides a more in-depth explanation, including steps to reproduce the issue, expected vs. actual behavior, and any relevant screenshots or logs. The priority and severity classify how urgent or critical the issue is. The assignee is the person or team responsible for resolving the ticket. The status reflects the current state of the issue (e.g., Open, In Progress, Resolved, Closed). The comments and attachments provide space for team members to collaborate by adding comments, sharing updates, and attaching relevant files or logs.

The Jira ticket serve as a centralized hub for tracking progress and managing the resolution of issues, ensuring that all relevant information is easily accessible to support and development teams. Jira ticket integrates well with other tools, enabling efficient communication and issue resolution across teams.

According to an embodiment, before associating the captured data with the Jira ticket, the method further comprises processing the comprehensive data set to extract a representation of the user actions. This extracted representation outlines the exact steps taken by the user that led to the issue, including actions such as navigating through menus, clicking buttons, entering data, or interacting with specific software features. These user actions are critical for reproducing the issue, which is essential for diagnosing and resolving the complaint.

In this embodiment, after capturing user interactions, the method proceeds to analyze the recorded data to identify one or more system components linked to the complaint. These system components include, but are not limited to, frontend elements (e.g., user interface elements like buttons, forms, or menus) and backend components (e.g., databases, APIs, or server processes).

The method uses techniques such as optical character recognition (OCR) to analyze screenshots or video recordings, speech-to-text conversion to process audio explanations provided by the user, and image analysis to detect error messages or important UI components. This analysis allows the system to understand the exact nature of the issue and the system components affected by it.

Once the system components have been identified, the method involves retrieving system data associated with these system components. This system data could include one or more of logs, events, diagnostic information, synchronization of system data and user interactions.

The logs include application logs that capture real-time events and error messages within the software. The events include system events that may have occurred during the user's interaction, such as database queries, network requests, or service failures. The diagnostic information includes detailed diagnostic reports that help identify performance issues, resource bottlenecks, or misconfigurations.

After retrieving the relevant system data, the method synchronizes this data with the captured user interactions. This synchronization is done using temporal or contextual markers, such as timestamps or event identifiers. For instance, the system may align an error log with the exact moment in the video where the user encounters the error, or associate a performance metric with a specific action (e.g., button click) that led to the issue. This synchronization ensures that all data points, both from the user and the system, are aligned to provide a clear, coherent view of the issue progression.

The synchronization process allows the development or support team to trace the user's steps in combination with the system's internal responses, making it easier to pinpoint the root cause of the problem.

Once the user actions and system data have been processed and synchronized, the system generates a Jira ticket that contains all relevant information captured from user interactions, including videos, screenshots, or audio recordings; extracted representation of user actions, detailing the steps the user took to reproduce the issue; system data, including logs, events, and diagnostic information, associated with the identified components. This support ticket acts as a comprehensive report that is forwarded to the support team 120 for further review.

Upon receiving the Jira ticket and the accompanying recorded issue information, the support team 120 can directly review the data without requiring further clarification from the customer. This data-driven approach drastically reduces the need for additional communication.

The support team 120 then forwards the complete recorded issue details to the development team 130, ensuring that all technical and diagnostic information is available for troubleshooting. Based on the details provided, the development team can promptly identify the root cause of the issue and resolve it. In step S150, once the issue is addressed, the development team 130 communicates the resolution back to the customer 110, either directly or via the support team.

In an embodiment of the disclosed method, despite the use of the user recordal interface 180 to capture comprehensive issue-related data, there may be cases where the development team 130 is unable to immediately identify the root cause of the issue based on the initial data provided. This scenario may occur in situations where the problem is complex, intermittent, or involves factors not fully captured by the automated logging and recording system.

Upon receiving the ticket, the development team 130 begins analyzing the collected data. While the comprehensive logs, video, and other diagnostic information generally enable the team to pinpoint the issue, certain cases may arise where the root cause remains elusive. This may happen if the issue is caused by interactions with third-party systems or external components not captured in the logs, the problem involves rare or intermittent behaviors that were not fully captured in the initial data, and the issue is environment-specific and not reproducible in the development environment.

In these cases, the development team 130 must communicate further with the customer 110 to gather more details or additional diagnostic data. The communication may occur as email communication. The development team 130 reaches out via email to request more information, such as whether the issue persists under different conditions or whether the customer has observed any additional symptoms.

In some instances, a phone call or live troubleshooting session is initiated. During this session, the development team might ask the customer to replicate the issue again while being monitored, providing real-time insights into how the system behaves.

During these follow-up communications, the development team 130 may instruct the customer to use the user recordal interface 180 again to capture additional user actions that were not recorded previously. Perform specific actions or tests suggested by the development team 130 to trigger the issue. Capture more logs from systems or software components that were not included in the initial recording. Provide more detailed verbal explanations or context, with this audio converted into text for the development team 130 to analyze.

Once the development team 130 receives the additional data, they combine it with the existing logs and recordings in the Jira ticket to further investigate the issue. In some cases, this process might involve escalating the problem to other teams or third-party providers, particularly if the issue involves external services or hardware.

After identifying the root cause, the development team 130 proceeds with resolving the issue. In step S150, the solution is communicated back to the customer, either through the support team 120 or directly, depending on the company's workflow. The customer is informed of the root cause, the fix that was applied, and any further actions they may need to take (e.g., updating software or resetting a configuration).

According to an exemplary embodiment of the disclosure, software as a Service (SaaS) bug reporting is discussed. In a SaaS environment, customers may encounter software bugs that are difficult to reproduce without technical knowledge. By introducing the user recordal interface 180, the process of reporting these bugs becomes user-friendly and automated. The customer can simply press the “Record Issue” button, which captures all necessary diagnostic information, reducing the need for the customer to manually describe the issue. This approach saves time for both the customer and the support teams, improving the overall user experience.

Additionally, using this method, the system captures detailed steps that the user performed, extracts relevant system logs, and synchronizes the two, allowing the support team to quickly identify and resolve the issue without requiring additional communication with the customer.

According to another exemplary embodiment, hardware or system-level error complaining steps have been discussed. For enterprises dealing with complex hardware or system-level issues, troubleshooting can require detailed logs from multiple sources (e.g., application logs, system performance data, and cloud services). The user recordal interface 180 simplifies the process by automatically capturing backend and frontend component data, CloudWatch logs, and more. This allows for faster diagnosis and resolution of system-level errors without needing extensive customer interaction.

Additionally, according to an embodiment, this method allows the system to not only capture the user's interactions but also retrieve logs from various components, such as databases or APIs, and synchronize them with the user's actions. This ensures that the development team has all the necessary context to resolve the issue efficiently.

According to another exemplary embodiment, enhanced customer support in enterprise systems is discussed. In larger enterprise systems, where multiple teams are involved in diagnosing and resolving issues, communication delays are common. By leveraging the user recordal interface 180, the support team can forward a complete package of logs, videos, and other diagnostics to the development team, minimizing the need for repeated clarifications. This ensures that complex issues are resolved efficiently, reducing customer wait times and improving the efficiency of the support system.

According to an exemplary embodiment related to troubleshooting in the healthcare industry. The software used in the healthcare industry often deals with critical data, where accuracy and timely issue resolution are essential. By leveraging this method, the system can capture all relevant user actions and associated system data (e.g., patient data errors, and diagnostic tool failures) and generate a detailed support ticket. The synchronized data allows the development team to address issues quickly while ensuring patient safety and data integrity.

This method offers several advantages over traditional issue-reporting processes including automation of data capture, faster resolution, seamless communication, and improved customer experience.

The automation of data capture includes the automated collection of logs, videos, and diagnostic information which eliminates the need for customers to manually document steps, reducing errors, and omissions. With all necessary information captured and shared in real-time, the development team can immediately begin working on the issue, reducing the time to resolution. The Jira ticket system, combined with comprehensive recorded data, ensures smooth communication between support and development teams without excessive back-and-forth exchanges. The streamlined process enhances the customer experience by simplifying issue reporting and providing faster resolutions.

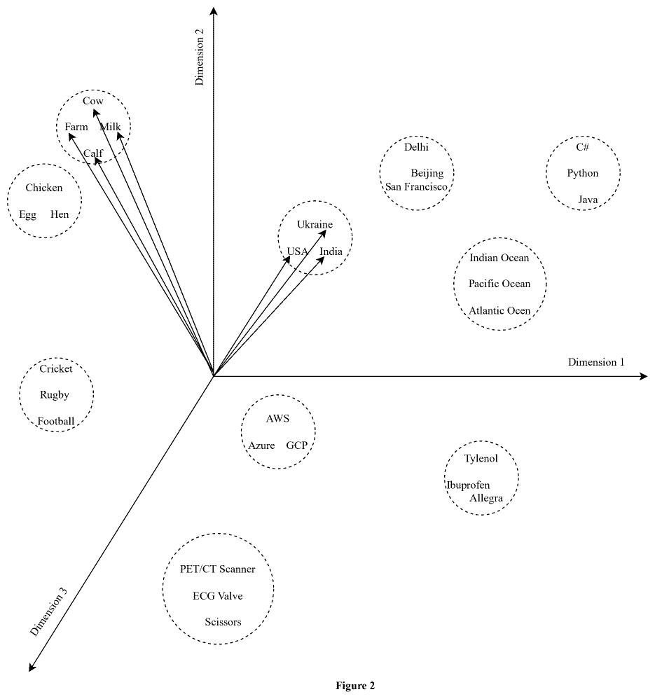

FIG. 2 illustrates word embedding in a 3D space according to an embodiment of the disclosure. The figure demonstrates the use of vector embeddings to represent different terms and entities in a multi-dimensional space, forming the foundation for a retrieval-augmented generation (RAG) architecture. This architecture is designed to handle data parsing, storage, and semantic search capabilities using large language models (LLMs).

While FIG. 1(b) illustrates the method for automating the collection of user interactions and generating support tickets, FIG. 2 introduces a further enhancement to the system by focusing on how the retrieved data—specifically, logs and user interactions—can be processed using word embeddings in a three-dimensional space. This process forms the backbone of RAG, which enables the system to semantically analyze the data and provide more accurate troubleshooting and contextual insights.

FIG. 2 builds upon the comprehensive data collection in FIG. 1(b) by introducing the concept of vector embeddings for both user actions and system components. These vector embeddings allow the system to represent complex data relationships in a way that facilitates faster and more accurate searches, diagnoses, and solutions.

As shown in FIG. 2, terms from various domains—geographical locations (e.g., India, USA, Delhi), programming languages (e.g., Java, Python, C #), industries, and medical terminologies—are represented as vectors in a 3D space. Each dimension (labeled as dimension 1, dimension 2, and dimension 3) captures relationships between the terms, allowing similar terms to be positioned closer to each other. For instance, geographical entities (e.g., USA, India, Beijing) are clustered in proximity. Programming languages (e.g., Java, Python, C #) form a separate group, showing their relationship based on semantic similarity. Medical terms (e.g., Tylenol, Ibuprofen, PET/CT Scanner) are grouped based on their relevance to healthcare. Cloud services (e.g., AWS, Azure, GCP) are also placed close together, indicating their contextual similarity.

The purpose of this embedding process is to allow semantic searches over a large dataset, where data such as CloudWatch logs, organizational details, audio-to-text transcriptions, and OCR-extracted text from screenshots are stored in an OpenSearch database as vector embeddings. These vectors represent specific issues or problem logs, enabling semantic search through LLMs.

For example, once the system ingests logs and other information into a vector database, it can answer user questions—either custom queries or predefined library questions—by retrieving relevant vectors. The RAG architecture allows for highly accurate responses to complex queries by analyzing the relationships between vectors and understanding the underlying data context.

FIG. 2 visually represents these concepts by positioning words or terms that share a high degree of semantic similarity close to one another, while unrelated terms are placed farther apart. This spatial arrangement reflects how word embeddings are used to facilitate efficient data retrieval and analysis in AI-driven search systems.

For example in CloudWatch log analysis, the vector embeddings allow the system to parse CloudWatch logs and store them as vectors indexed by specific issues or system behaviors. When an LLM is queried with a question like, “What errors occurred in AWS during the last deployment?”, it can retrieve the most relevant vectors containing logs and error codes related to that query.

In the case of a medical diagnostic system, in a healthcare setting, the system can store medical logs and reports as vectors. For instance, terms like PET/CT scanner and ECG valve can be semantically related to patient diagnostic records. A healthcare provider can ask, “What were the PET scan results for this patient?” and the system can semantically search the vectors to retrieve relevant medical data.

In customer support, for tech support teams, storing support tickets, logs, and screenshots as vector embeddings allows for faster issue resolution. If a customer asks, “What are the known solutions for memory leaks in Java?”, the system can retrieve relevant logs and past solutions indexed by the query, enhancing troubleshooting efficiency.

In cross-domain search capabilities, the vectorized data can span multiple domains, from geographical terms to cloud services. In a cross-domain query, users might ask questions like, “Which cloud provider offers the best pricing for Pacific region services?” The embeddings related to AWS, Azure, GCP, and geographical terms (e.g., Pacific Ocean) allow the system to generate contextually accurate answers.

By leveraging word embeddings in this 3D space, the disclosed embodiment provides a robust framework for retrieval-augmented generation, facilitating advanced data analysis and search capabilities in various domains such as cloud computing, healthcare, software development, and customer support.

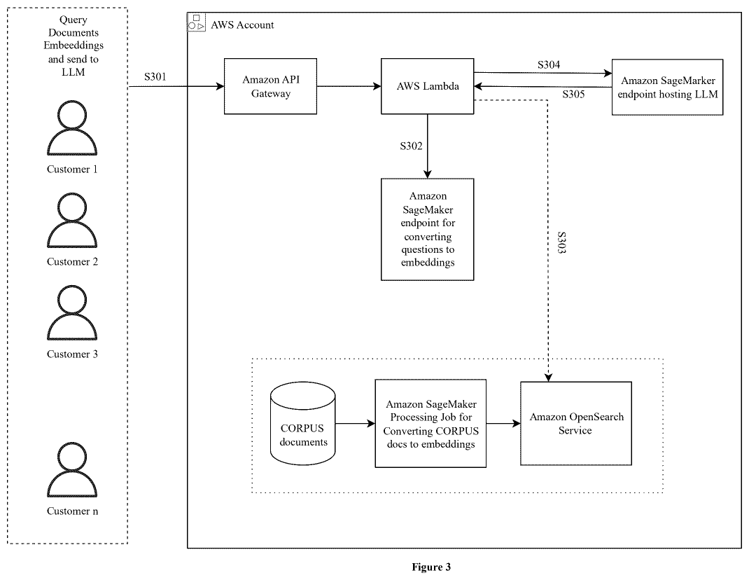

FIG. 3 illustrates a process flow for querying and retrieving information using a virtual assistant in conjunction with a Retrieval-Augmented Generation (RAG) system according to an embodiment of this disclosure. The method includes the steps for querying, embedding, and retrieving responses from a large language model (LLM) via various AWS services.

The steps outlined in FIG. 3 are as follows. The process begins at S301, when a customer (e.g., Customer 1, Customer 2, . . . Customer n) interacts with a virtual assistant, submitting a query related to an issue or request. This query is sent through an API Gateway, which acts as an interface between the customer and the backend services, managing the request.

At step S302, the query is converted into a vector. Once the query is received, the virtual assistant sends it to an Amazon SageMaker endpoint. The endpoint converts the query into a vector embedding. Embeddings represent the query in a mathematical form that encodes its meaning and context, enabling efficient retrieval of relevant information. These embeddings are key to performing semantic searches in the vector database.

At step S303, the vector from the vector database is found using a kNN similarity search. After the query is converted into an embedding, the system performs a similarity search using the k-Nearest Neighbors (kNN) algorithm in the Amazon OpenSearch Service. The search identifies vectors from the vector database that are closest in distance to the query embedding. These vectors correspond to documents or data points that are semantically related to the user's query, ensuring that the most relevant information is retrieved.

At step S304, the method involves invoking SageMaker endpoint hosting the LLM. Once the relevant vectors are identified, the system invokes another Amazon SageMaker endpoint that hosts the Large Language Model (LLM). The LLM processes the query along with the identified vectors (query+embedding) to generate an appropriate answer. This step uses the context provided by the retrieved embeddings to generate a more accurate and context-aware response.

At step S305, the method comprises getting a response with source documents. Finally, the system returns the generated response, along with the source documents that informed the LLM's answer. These documents may include related logs, articles, or technical documents stored in the corpus database. The response and documents are sent back to the virtual assistant, which then presents the answer to the customer.

In a technical support system, customers may ask the virtual assistant questions related to software bugs or errors. For example, a customer might ask, “How can I resolve memory leaks in my Java application?” The query is transformed into a vector, and the system performs a kNN similarity search to retrieve related documents such as previous support tickets or logs. The LLM processes this information and returns the most relevant troubleshooting steps, along with source documents, back to the customer.

In a healthcare setting, a clinician may ask the virtual assistant for information on a specific treatment or medical device. The query is embedded and searched against a database of medical documents. The LLM returns a response, along with relevant medical journals or device manuals, enabling the clinician to access accurate and up-to-date information quickly.

For cloud service management, a system administrator may ask the virtual assistant to diagnose issues in AWS CloudWatch logs. The system would convert the query into an embedding, search through stored log vectors, and retrieve documents that contain relevant log entries. The LLM would then analyze these logs to provide a summarized diagnosis, helping the administrator troubleshoot the cloud infrastructure more effectively.

By converting queries into vectors and performing similarity searches, the system ensures that only the most relevant information is retrieved, reducing noise, and improving the accuracy of the results. The LLM, combined with vector embeddings, provides responses that are contextually rich and tailored to the specific query, improving user satisfaction.

Leveraging AWS services such as SageMaker, Lambda, and OpenSearch, the system can scale to handle large volumes of queries and data, making it suitable for enterprise environments. The architecture can integrate with various data sources (e.g., support tickets, technical logs, medical documents), making it adaptable for different use cases, from technical support to healthcare.

FIG. 3 demonstrates the integration of multiple AWS components to create a seamless and intelligent query-response system. By leveraging vector embeddings, similarity search algorithms, and LLMs, the system can deliver highly relevant and context-aware responses to user queries, along with supporting documentation. This architecture provides a powerful tool for improving customer support, knowledge retrieval, and decision-making in complex domains.

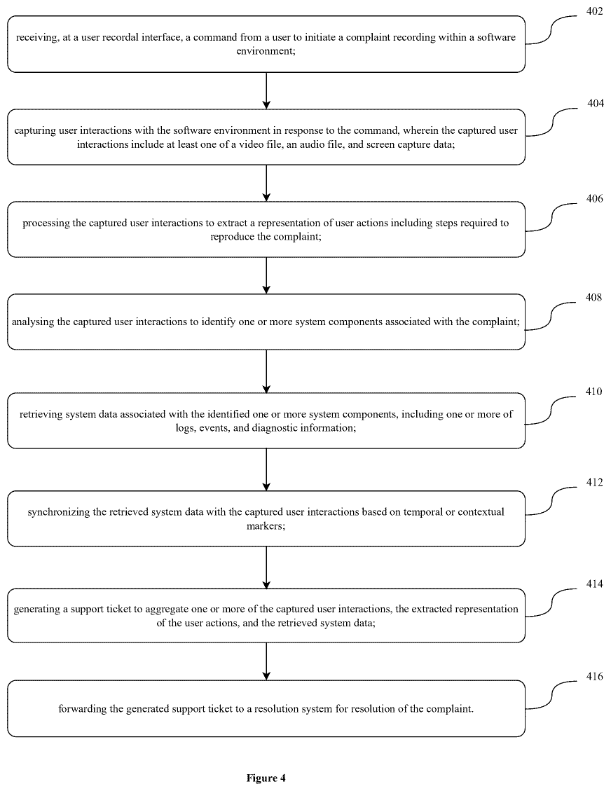

FIG. 4 illustrates a method for automated logging of user complaints according to an embodiment of the disclosure. This method enables a streamlined and efficient process for capturing and analyzing user interactions within a software environment to address complaints or issues.

The process begins at step 402, where a user recordal interface receives a command from the user to initiate a complaint recording. This interface could be a button or an option in the software, allowing users to trigger the recording when they encounter an issue. Upon initiation, the system begins capturing the user's interactions with the software at step 404, which includes video files, audio files, and screen capture data, depending on the nature of the complaint and the available data sources.

In one embodiment, the user recordal interface can be a simple button labeled “Record Issue” or “Report Problem.” The user clicks this button when they encounter an issue, and the system starts capturing their interactions with the software. This approach is effective in standard desktop or web-based applications where users can easily access the interface.

According to an exemplary embodiment, once initiated, the system captures screen recording to visually document the steps taken by the user (e.g., navigating through menus, interacting with UI elements); audio capture if the user verbally describes the issue while interacting with the software; and browser logs or application logs to document system-level information and errors. This embodiment is suitable for software with a graphical interface, where visual and auditory cues are critical to reproducing the issue.

In another embodiment, the user can initiate the recording process through a contextual menu (right-click or drop-down menu). For instance, the user may right-click on the screen and select an option like “Start Recording” from the drop-down list.

In an exemplary embodiment, after activation, the system may perform a targeted screen capture of the specific section where the user encountered the issue. Logs related to the specific screen or UI element are captured, focusing on the context where the error occurred. Text input logs may also be captured to document any user-provided input that led to the issue. This approach is ideal for applications where the user might want to focus on specific elements or areas of the screen while reporting an issue.

According to another embodiment, a system automatically detects when an issue occurs, such as an error message or application crash, and prompts the user with a recording option. For instance, if an application crash is detected, a prompt might appear, asking the user, “Would you like to record this issue and report it?”

In an exemplary embodiment, once the user accepts, the system retroactively captures error logs, performance data, and any recent screen activity leading up to the crash. The system also records the error message and any accompanying system diagnostics. If the user provides further context via audio or text, that information is captured as well. This embodiment is particularly useful in scenarios where issues may not be immediately reproducible, such as software crashes or intermittent performance problems.

In another embodiment, the system could employ continuous background recording, where the user's interactions are captured in real-time, and the last few minutes of interaction are stored in a temporary buffer. When the user encounters an issue, they can initiate the recording, which automatically saves the buffered data along with any subsequent actions.

According to an exemplary embodiment, buffered screen recording to capture interactions leading up to the issue. Real-time logs of user actions and system behavior. Network and performance logs to capture background operations (useful for tracking latency, connectivity issues, or backend system failures). This embodiment is ideal for debugging intermittent issues that may not be immediately reproducible or may occur during regular use of the software.

For mobile applications, the user recordal interface may take the form of a gesture-based initiation (e.g., shaking the device or swiping a specific direction). When the user performs the gesture, the system starts recording their interactions. For capturing, screen recording to capture user interactions on the mobile app interface can be used. Device logs, such as CPU usage, memory performance, or network activity, are captured to help identify issues. If the device supports it, audio capture can also be included to allow the user to describe the issue while interacting with the app. This embodiment is useful for mobile apps where buttons or contextual menus might interfere with the user's normal experience, providing a seamless and intuitive way to report problems.

According to an embodiment, in certain voice-controlled or smart assistant-enabled software environments, the user could initiate the complaint recording through voice commands. For example, the user may say, “Record this issue” to start the process.

For instance, the system captures screen recordings and audio descriptions as the user verbally explains the issue. Logs and system data related to the voice command processing and subsequent actions are also captured. The system might also capture transcriptions of the voice input for further analysis. This embodiment is ideal for environments where the user may not have access to a keyboard or mouse, such as in automotive systems, voice-controlled IoT devices, or smart home systems.

In a complex software environment involving multiple platforms (e.g., web, mobile, desktop), a hybrid embodiment may be employed, where the system captures user interactions from different sources (e.g., a web application and a mobile companion app). The recording is triggered on one platform and continues across different devices.

For instance, cross-platform screen recordings showing user interactions on both the web and mobile interfaces. Logs from all connected platforms (e.g., network logs, mobile logs, API logs). Synchronization of real-time interactions and logs across multiple platforms to ensure consistency in reproducing the issue. This embodiment is suitable for applications where users interact with multiple platforms, and issues could arise from interactions between different devices.

By providing various ways to initiate and capture the complaint, users can easily adapt the system to their environment and the specific nature of the issue. These methods allow the system to collect a wide range of data—such as user interactions, system logs, and real-time performance data—ensuring that the support team has all necessary information for diagnosis and resolution. These embodiments are versatile and can be applied across desktop, web, mobile, and voice-controlled environments, ensuring that users can capture issues no matter where or how they occur.

At step 406, the captured user interactions are processed to extract a detailed representation of the user's actions, such as steps taken to reproduce the issue. This step is crucial as it forms the basis for identifying the root cause of the problem.

In one embodiment, the method uses machine learning and artificial intelligence (AI) algorithms to map user interactions automatically. The AI model learns from previous user behaviors and issues to predict which actions are most likely to have caused the problem. The model processes the screen recording, logs, and audio, and suggests possible root causes based on patterns it has seen in similar reports. This embodiment allows for an intelligent extraction of user actions and system responses, providing deeper insights without requiring manual analysis.

In another embodiment, the system creates a replayable visualization of the user's actions. The extracted steps are rendered in an interactive format that allows the support team to replay the user's journey within the software, step by step. This replay feature includes highlights of critical actions, such as clicks, text inputs, and navigation; display of log data and error messages at the moment they occurred; and visualization of system performance metrics alongside user actions, such as showing network latency or resource consumption when the user clicked a specific button.

This embodiment is especially useful for support teams who need to recreate the issue or understand the context behind the user's actions without relying on a static description or screen recording.

In some environments, the method can include a real-time interaction monitor that tracks user actions as they happen, without waiting for an issue report. In this embodiment, the system actively captures user interactions, logs, and system performance metrics in real-time, which can then be analyzed whenever an issue is reported.

The user's actions are logged continuously, and the system stores recent interactions in a buffer. If the user triggers an issue report, the system extracts the most recent actions (e.g., the last 5 minutes) and associates them with the complaint. Real-time error messages, performance warnings, and resource bottlenecks are linked directly to the user's actions. This embodiment is particularly useful for intermittent issues or when real-time data is necessary to reproduce complex system behavior.

Another embodiment involves context-aware extraction of user actions. Here, the system applies contextual markers to the user interactions to determine the most relevant actions based on the specific issue being reported. For example, the system may prioritize actions related to navigation errors if the issue relates to page loading or UI responsiveness, and it may focus on backend processes if the user reports a data processing error or network issue. This contextual awareness ensures that the extraction process is optimized to focus on the most likely causes of the problem, reducing the noise in the data and providing a clear representation of the issue.

Following the extraction of user actions, the system analyzes the interactions at step 408 to identify one or more system components associated with the complaint. This analysis involves recognizing patterns in the user's behavior and the software's response, as well as identifying system areas affected by the issue. The system then retrieves relevant system data at step 410, which could include logs (e.g., application logs, network logs), events, and diagnostic information. This system data provides valuable context to the captured user interactions and helps in diagnosing the root cause of the issue.

In some embodiments, advanced recognition techniques are applied during the analysis of user interactions, such as OCR, speech-to-text conversion, and image analysis. The OCR is used to extract text from screenshots or video captures of the user's interface. The speech-to-text conversion converts audio explanations into text, allowing further analysis of the user's verbal description of the issue. The image analysis identifies UI components, buttons, or error messages in screen captures.

At step 412, the system synchronizes the retrieved system data with the captured user interactions based on temporal or contextual markers. For instance, logs or events may be time-stamped to match specific user actions, providing an organized and coherent view of the issue's progression.

For instance, system logs and events—such as errors, API calls, database queries, and system performance metrics—are often time-stamped. By comparing these timestamps to the moments when the user performed specific actions (e.g., clicking a button, navigating between pages), the system can correlate the user's actions with system behaviors in real-time. This allows support teams or automated diagnostic tools to see the exact sequence of events, identify potential causes of the issue, and better understand how the system responded to the user's actions.

The synchronization process involves several key steps, ensuring that the user interactions and system data are correctly aligned, including time-based synchronization and event-based synchronization. In many cases, both the user's actions and system data are recorded with timestamps. The system uses these timestamps to align user actions (such as clicking buttons or submitting forms) with the system responses (such as backend processing or log generation); and errors, warnings, or performance anomalies that appear in the logs with the specific moment a user action occurred.

For example, if a user clicks a “Submit” button and experiences a delay, the system might synchronize the network logs showing the request initiation with the timestamp of the user's click, revealing if there were any network delays or server-side issues at that time.

Beyond time-based synchronization, the system may use event markers to synchronize interactions. Events such as database transactions including query execution or data retrieval; API calls made to external services, including their status (e.g., success, failure); and system-level events, such as crashes, warnings, or resource bottlenecks (e.g., memory or CPU spikes).

These events are synchronized with the user interactions to ensure that each significant action the user performed is linked to the appropriate system behavior or event. For example, if the system logs an out-of-memory error, the system would synchronize it with the moment the user performed a resource-intensive operation, like uploading a large file.

In some embodiments, the method synchronizes user actions based on contextual markers, such as, error codes generated in the logs or system events; performance metrics, such as CPU or memory usage spikes that correspond to a user's action; and network logs, such as latency or timeout errors, that can be matched to a user's interaction with a web-based system.

By matching the content of system logs or events (e.g., error codes) to specific user actions, the system provides a more granular synchronization, which is particularly useful when diagnosing complex issues that involve multiple system components.

In one embodiment, the system uses machine learning models to automatically detect and synchronize user actions with system data, especially when the issue involves complex, multi-component interactions. The machine learning model is trained to recognize patterns between user actions and system behaviors, improving the accuracy of synchronization even when there are subtle timing discrepancies between the two.

For instance, if a user reports slow performance, the machine learning model could analyze a combination of user clicks, backend logs, and network performance data to pinpoint the moment when the slowdown occurred and its likely cause (e.g., network latency, database overload, or inefficient API calls).

In another embodiment, the system uses artificial intelligence (AI) to perform context-aware synchronization. This method involves the AI analyzing both the content and timing of the user interactions and system data to understand the context of the issue and synchronize them more accurately.

For instance, when an error message is generated in the backend logs, the AI would synchronize it with the precise step in the user interaction flow that triggered the error. The AI might also use natural language processing (NLP) to parse the error message and match it with user actions that align with the system's response.

This embodiment is particularly useful for complex software environments where various system components interact, and the issue cannot be easily traced back to a single user action or log event.

In another embodiment, the system performs real-time synchronization between user interactions and system data as the user performs actions. This is especially useful for troubleshooting live issues, where the system continuously captures user actions and system logs in parallel.

For instance, as the user navigates the software, any logs or system events generated are immediately synchronized with the corresponding user actions. If the user encounters an issue (e.g., the application crashes or becomes unresponsive), the system can instantaneously identify the last action taken before the issue occurred and match it to the logs or events recorded at that moment. This real-time embodiment is ideal for live debugging in environments like cloud services or customer support systems, where rapid issue resolution is critical.

In step 414, the system generates a support ticket that aggregates all collected data, including: the captured user interactions (video, audio, or screenshots), the extracted representation of the steps taken by the user, the retrieved system data (logs, events, and diagnostic information).

Finally, in step 416, the generated support ticket is forwarded to a resolution system, where it is processed for the resolution of the complaint. This method ensures that the support or development team has comprehensive and organized information about the issue, minimizing the need for back-and-forth communication with the user.

In some embodiments, the system captures and processes a detailed representation of user actions, including, clicking buttons, entering text in forms, navigating through different screens or windows, and performing any other interactions within the software environment, this detailed log of user actions allows the support team to reproduce the issue accurately, leading to faster diagnosis and resolution.

The method further comprises storing the generated support ticket in a database. To improve future retrieval and comparison, the support ticket is organized by associating it with indexing structures. These structures are designed to support the retrieval of tickets based on similarities in complaint characteristics, such as related system components or recurring issues. Each ticket is assigned a unique identifier, making it easier to track and resolve similar complaints.

In some embodiments, retrieving system data involves accessing information from multiple sources, including: application logs, which provide insights into the software's internal processes; network logs, which help diagnose connectivity or latency issues; performance metrics, which can reveal whether the issue is linked to system resource utilization (e.g., memory or CPU bottlenecks); user-specific data, which includes personalized settings or environment-specific issues; and Machine Learning and AI Integration.

In some embodiments, the system utilizes machine learning or artificial intelligence (AI) models to improve the accuracy of the extracted user actions and to enhance the identification of system components linked to the complaint. AI models can analyze historical data to predict which components are most likely associated with the issue and suggest possible fixes based on patterns observed in past tickets.

Further, the generated support ticket and all associated data (user interactions, system logs, and steps to reproduce the issue) are presented to either the user or the resolution system through a user interface. The interface can include visual elements, such as charts, screenshots, or video playback of the user's actions; textual elements, such as logs, error messages, or transcriptions of user audio; interactive elements, allowing the support team to interact with the data (e.g., play, pause, or review logs and error traces).

In a SaaS environment, customers may encounter issues related to performance or functionality. Using this automated logging method, the system can capture detailed information about user actions and system behavior, reducing the need for manual descriptions by the customer and speeding up the troubleshooting process.

In large-scale enterprise software, where issues may arise due to complex infrastructure or integrations, this method captures both user interactions and detailed system logs, providing a comprehensive view for technical support teams. For instance, if a network latency issue affects a financial application, the system can capture logs from the network, application, and user interface, making it easier to pinpoint the root cause.

In healthcare systems, ensuring the accuracy of issue reproduction is critical. This method allows support teams to capture both the user's interaction with medical software (e.g., interacting with patient records) and the corresponding system data, ensuring that patient safety and data integrity are maintained during troubleshooting. Reduces the burden on users by automatically capturing relevant data about their actions and the system's response. Aggregates all necessary information into a single support ticket, improving the efficiency of issue resolution. Machine learning models enhance the system's ability to accurately identify relevant system components and suggest resolutions.

By providing detailed information upfront, the method minimizes the need for repeated communication between the customer and support teams, leading to faster issue resolution. The method can be applied across various industries, from SaaS platforms to healthcare and enterprise-level software.

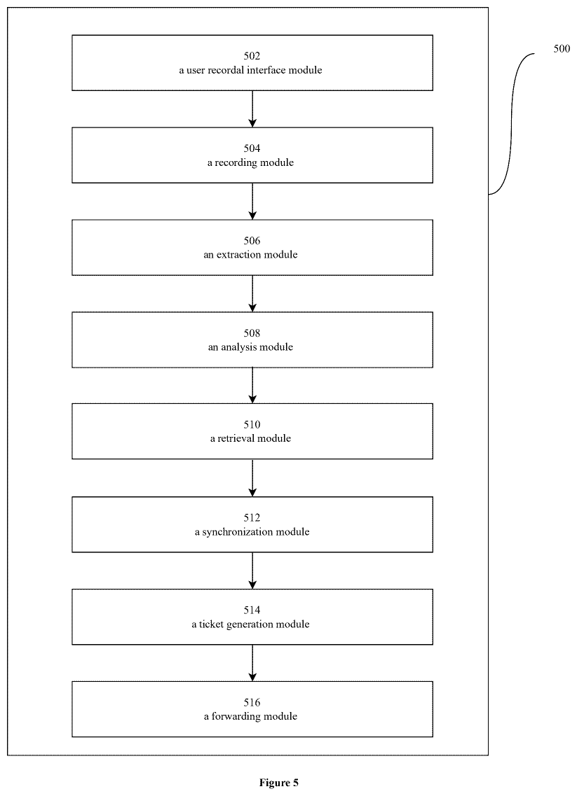

FIG. 5 illustrates a user recordal system 500 for the automated logging and resolution of user complaints according to an embodiment of the disclosure. The system is designed to efficiently capture, analyze, and process user interactions within a software environment to streamline the troubleshooting and support process.

The user recordal system 500 comprises several interconnected modules that work together to handle user complaints, including a user recordal interface module 502, a recording module 504, an extraction module 506, an analysis module 508, a retrieval module 510, a synchronization module 512, a ticket generation module 514, and a forwarding module 516.

Each of these modules is included in the complaint logging process to ensure that all relevant data is captured and processed accurately.

The user recordal interface module 502 receives a command from the user recordal interface (such as a button or tab in the software) to initiate the complaint recording process. Once the user identifies an issue, they can trigger the system to begin capturing their interactions with the software, streamlining the initial reporting phase.

In response to the user's command, the recording module 504 captures user interactions within the software environment. This includes various types of data, such as video files that show the user's actions on the screen, audio files that capture verbal explanations or commentary, screen capture data that records the current state of the software, error messages, or other relevant information.

The extraction module 506 processes the captured interactions to extract a representation of the user's actions, particularly focusing on the steps that reproduce the complaint. This module ensures that key details, such as button clicks, navigation paths, and text inputs, are preserved in a structured format for further analysis.

The analysis module 508 analyzes the extracted data to identify the system components related to the complaint. In some embodiments, the analysis module 508 applies advanced recognition techniques, such as optical character recognition (OCR) which extracts text from screenshots or video frames to identify error messages or system status; speech-to-text conversion that converts audio explanations into text for further processing; image analysis that detects and analyzes user interface elements, error messages, or screen states to associate with the complaint. Additionally, the module 508 can generate a unique identifier for the support ticket, which allows it to be tracked and organized in the system.

Once the system components associated with the complaint are identified, the retrieval module 510 retrieves related system data. This may include application logs to track the software's internal processes, network logs to diagnose connectivity issues, performance metrics to identify resource bottlenecks, and user-specific data, such as configuration settings or session details. In some embodiments, the retrieval module 510 aggregates data from multiple sources, ensuring that all relevant information is captured to assist in resolving the complaint.

The synchronization module 512 synchronizes the retrieved system data with the captured user interactions using temporal or contextual markers. For example, it aligns timestamps from logs with specific user actions, ensuring that the data is consistent and easy to analyze. This provides the support team with a clear, step-by-step view of the issue as it unfolded.

The ticket generation module 514 compiles all the captured and processed data into a support ticket. The ticket includes the user's recorded interactions, the extracted steps to reproduce the issue, and relevant system data (logs, performance metrics, etc.). This ticket is a comprehensive package of information that allows support teams to quickly diagnose and resolve the issue.

Finally, the forwarding module 516 sends the generated support ticket to the appropriate resolution system. This system could be a support team, a development team, or an automated troubleshooting platform, depending on the organization's workflow. The ticket is forwarded for further investigation and eventual resolution of the user's complaint.

In some embodiments, the system includes a storing module to save the generated support tickets in a database. The analysis module 508 organizes these tickets using indexing structures that allow for easy retrieval and comparison. The system can support retrieval based on similarities in complaint characteristics, such as common error types, system components, or user actions. Each ticket is assigned a unique identifier, making it easier to track and analyze complaints over time.

In some embodiments, the system incorporates a machine learning (ML) module or artificial intelligence (AI) module to improve the accuracy of the extracted representation of user actions and the identification of system components. By learning from previous complaints and resolutions, the AI can predict which components are most likely involved in a particular issue, streamlining the diagnosis process.

In some embodiments, the system includes a user interface module to present the generated support ticket and associated data to either the user or the resolution team. The presentation can include visual elements, such as video playback or graphical representations of logs, textual elements, such as system logs or transcriptions of audio, interactive elements, allowing users or support teams to interact with the data, such as replaying video segments or filtering log entries.

In an exemplary embodiment, in a Software as a Service (Saas) environment, users often encounter bugs or performance issues that need detailed explanation. The user recordal system 500 allows the system to automatically capture all relevant data without requiring the user to manually describe the issue. This reduces the time needed to diagnose and resolve problems, leading to higher customer satisfaction.

In enterprise-level software environments, where systems are complex and logs come from multiple sources (e.g., application, network, and performance logs), the user recordal system 500 aggregates all relevant data into one support ticket. This allows IT teams to troubleshoot and resolve issues more quickly, even in multi-system environments.

In healthcare software, where system reliability and accuracy are critical, the user recordal system 500 can ensure that all user interactions and system data are captured comprehensively. By using ML/AI modules, the system can prioritize critical issues and alert support teams to urgent problems, improving response times in high-stakes environments.

For cloud-based services, issues can stem from network outages, resource limitations, or misconfigurations. The user recordal system 500 captures both the user's experience and backend data (e.g., from AWS CloudWatch), allowing for seamless analysis of cloud-related issues and faster troubleshooting. Further, automated data collection captures comprehensive user interaction data, reducing manual effort by the user. Improves diagnostic accuracy by synchronizing system data with user actions, providing a clear timeline of the issue. Enhances resolution workflow by aggregating all necessary data into a structured support ticket, streamlining the resolution process for support teams. Additionally, machine learning integration helps in learning from past cases to improve the accuracy and speed of issue diagnosis.

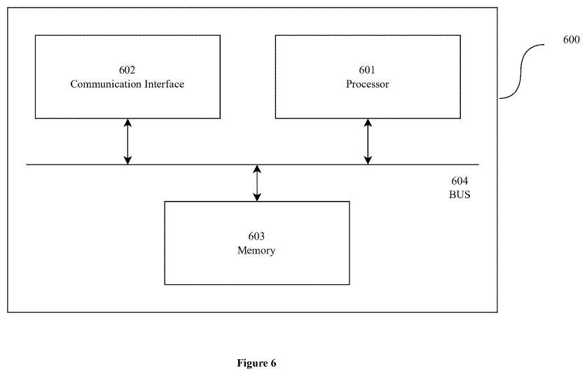

FIG. 6 illustrates a schematic diagram of another communication apparatus 600 according to an embodiment of the disclosure. The communication apparatus 600 includes a processor 601, a communication interface 602, and a memory 603. The processor 601, the communication interface 602, and the memory 603 may be connected to each other via a bus 604. The bus 604 may be a peripheral component interconnect (peripheral component interconnect, PCI) bus, an extended industry standard architecture (extended industry standard architecture, EISA) bus, or the like. The bus 604 may be classified into an address bus, a data bus, a control bus, and the like. For ease of representation, the bus is represented by using only one line in FIG. 4, but it does not indicate that there is only one bus or one type of bus. The processor 601 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 603 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

1. A method for automated logging of user complaints, comprising the steps of:
receiving, at a user recordal interface, a command from a user to initiate a complaint recording within a software environment;
capturing user interactions with the software environment in response to the command, wherein the captured user interactions include at least one of a video file, an audio file, and screen capture data, and wherein the capturing comprises recording a sequence of user actions performed within the software environment;
storing the recorded sequence of user actions in a database;
processing the captured user interactions to extract a representation of user actions including steps required to reproduce the complaint using the stored recorded sequence of user actions;
analysing the captured user interactions to identify one or more system components associated with the complaint;
retrieving system data associated with the identified one or more system components, including one or more of logs, events, and diagnostic information;
synchronizing the retrieved system data with the captured user interactions based on temporal or contextual markers, wherein the synchronization aligns system logs and events with specific user actions in real time using timestamps or event identifiers;
generating a support ticket to aggregate one or more of the captured user interactions, the extracted representation of the user actions, and the retrieved system data; and
forwarding the generated support ticket to a resolution system for resolution of the complaint.

2. The method as claimed in claim 1, further comprising:
storing the generated support ticket in the database; and
organizing the stored support ticket by associating the stored support ticket with one or more indexing structures, wherein the one or more indexing structures are configured to support the retrieval and comparison of the support ticket based on similarities in the complaint characteristics.

3. The method as claimed in claim 1, wherein analysing the captured user interactions comprises applying recognition techniques including one or more of optical character recognition (OCR), speech-to-text conversion, or image analysis to identify relevant system components and contextual information.

4. The method as claimed in claim 1, wherein retrieving the system data comprises accessing and aggregating the system data from a plurality of sources including one or more of application logs, network logs, performance metrics, and user-specific data.

5. The method as claimed in claim 1, further comprising utilizing machine learning or artificial intelligence models to enhance the accuracy of the extracted representation of the user actions and the identification of one or more system components.

6. The method as claimed in claim 1, further comprising presenting the generated support ticket and associated data including one or more of the captured user interactions, the extracted representation of the user actions, and the retrieved system data to the user or the resolution system via a user interface, wherein the presenting includes at least one of visual elements, textual elements, or interactive elements.

7. The method as claimed in claim 2, wherein organizing the stored support ticket comprises generating a unique identifier for the stored support ticket in the database.

8. The method as claimed in claim 1, wherein the representation of the user actions includes recorded steps performed by the user including at least one of clicking buttons, entering text, navigating through different screens, or other interactions with the software environment.

9. A user recordal system for automated logging of user complaints, comprising:
a user recordal interface module configured to receive a command from a user recordal interface to initiate a complaint recording within a software environment;
a recording module configured to capture user interactions with the software environment in response to the command, wherein the captured user interactions include at least one of a video file, an audio file, and screen capture data, and wherein the capturing comprises recording a sequence of user actions performed within the software environment;
a storage module configured to store the recorded sequence of user actions in a database;
an extraction module configured to process the captured user interactions to extract a representation of user actions including steps required to reproduce the complaint using the stored recorded sequence of user actions;
an analysis module configured to analyse the captured user interactions to identify one or more system components associated with the complaint;
a retrieval module configured to retrieve system data associated with the identified one or more system components, including one or more of logs, events, and diagnostic information;
a synchronization module configured to synchronize the retrieved system data with the captured user interactions based on temporal or contextual markers, wherein the synchronization aligns system logs and events with specific user actions in real time using timestamps or event identifiers;
a ticket generation module configured to aggregate one or more of the captured user interactions, the extracted representation of the user actions, and the retrieved system data into a support ticket; and
a forwarding module configured to forward the generated support ticket to a resolution system for resolution of the complaint.

10. The user recordal system as claimed in claim 9, further comprising a storing module configured to store the generated support ticket in the database, wherein the analysis module is further configured to organize the stored support ticket by associating the stored support ticket with one or more indexing structures, and wherein the one or more indexing structures are configured to support the retrieval and comparison of the support ticket based on similarities in the complaint characteristics.

11. The user recordal system as claimed in claim 9, wherein the analysis module is further configured to apply recognition techniques to analyse the captured user interactions, including one or more of optical character recognition (OCR), speech-to-text conversion, or image analysis to identify relevant system components and contextual information.

12. The user recordal system as claimed in claim 9, wherein the retrieval module is further configured to access and aggregate the system data from a plurality of sources including one or more of application logs, network logs, performance metrics, and user-specific data.

13. The user recordal system as claimed in claim 9, further comprising a machine learning module or artificial intelligence module configured to enhance the accuracy of the extracted representation of the user actions and the identification of one or more system components.

14. The user recordal system as claimed in claim 9, further comprising a user interface module configured to present the generated support ticket and associated data including one or more of the captured user interactions, the extracted representation of the user actions, and the retrieved system data to the user or the resolution system, wherein the presentation includes at least one of visual elements, textual elements, or interactive elements.

15. The user recordal system as claimed in claim 10, wherein the analysis module is further configured to generate a unique identifier for the stored support ticket in the database.

16. A non-transitory computer-readable medium having stored thereon computer-executable instructions that, when executed by a processor, cause the processor to execute a method for automated logging of user complaints, comprising:
receiving, at a user recordal interface, a command from a user to initiate a complaint recording within a software environment;
capturing user interactions with the software environment in response to the command, wherein the captured user interactions include at least one of a video file, an audio file, and screen capture data, and wherein the capturing comprises recording a sequence of user actions performed within the software environment;
storing the recorded sequence of user actions in a database;
processing the captured user interactions to extract a representation of user actions including steps required to reproduce the complaint;
analysing the captured user interactions to identify one or more system components associated with the complaint using the stored recorded sequence of user actions;
retrieving system data associated with the identified one or more system components, including one or more of logs, events, and diagnostic information;
synchronizing the retrieved system data with the captured user interactions based on temporal or contextual markers, wherein the synchronization aligns system logs and events with specific user actions in real time using timestamps or event identifiers;
generating a support ticket to aggregate one or more of the captured user interactions, the extracted representation of the user actions, and the retrieved system data; and
forwarding the generated support ticket to a resolution system for resolution of the complaint.

17. The non-transitory computer-readable medium as claimed in claim 16, wherein the computer-executable instructions cause the processor to:
store the generated support ticket in the database; and
organize the stored support ticket by associating the stored support ticket with one or more indexing structures, wherein the one or more indexing structures are configured to support the retrieval and comparison of the support ticket based on similarities in the complaint characteristics.

18. The non-transitory computer-readable medium as claimed in claim 16, wherein the computer-executable instructions cause the processor to apply recognition techniques to analyse the captured user interactions, including one or more of optical character recognition (OCR), speech-to-text conversion, or image analysis to identify relevant system components and contextual information.

19. The non-transitory computer-readable medium as claimed in claim 16, wherein the computer-executable instructions cause the processor to access and aggregate the system data from a plurality of sources including one or more of application logs, network logs, performance metrics, and user-specific data.

20. The non-transitory computer-readable medium as claimed in claim 16, wherein the computer-executable instructions cause the processor to:
enhance the accuracy of the extracted representation of the user actions and the identification of one or more system components.
